(19) United States
(12) Patent Application Publication
(10) Pub. No.: US 2024/0073366 A1
(43) Pub. Date: Feb. 29, 2024

(54) INCLUSIVE SCREEN SHARING WITH ONLINE MEETINGS

(71) Applicant: Microsoft Technology Licensing, LLC, Redmond, WA (US)

(72) Inventors: Cavill DSOUZA, Bothell, WA (US); Murat TORLAKCIK, Dublin (IE); Juan José MONTIEL PÉREZ, Dun Laoghaire (IE); Ivan SHASTIN, Dublin (IE)

(21) Appl. No.: 17/893,909

(22) Filed: Aug. 23, 2022

(51) Int. Cl. H04N 7/15; G06F 3/14; H04L 12/18

(52) U.S. Cl. CPC H04N 7/152; G06F 3/1454; H04L 12/1818; H04L 12/1831; H04L 12/1895

(57) ABSTRACT

The present disclosure relates to methods and systems for detecting the links for webpages presented by users through screen sharing during an online meeting. The methods and systems post the links for the webpages in the meeting chat in near real time during the online meeting. The links for the webpages are available for access in the meeting chat during the online meeting and after the online meeting finishes.

### BACKGROUND

In today's scenario, online meetings are a vital part for both working and non-working organizations. Users at remote locations communicate to one another in a collaborative environment using online meeting tools. These tools allow users to share their screen, which may have distinct contents, such as, audio, video, and/or images. The shared content may also have website links or web pages. The website links may be helpful for the meeting audience, and they often may need to view or click on the website links during the live meeting. It is quite tedious for the presenter to share the links in a meeting chat and/or messaging box while presenting during the online meeting.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some implementations relate to a method. The method includes receiving, from a browser extension on a browser, a link of a webpage accessed via the browser by a user during an online meeting. The method includes determining that the user is screen sharing on a device while accessing the link. The method includes sending the link to a meeting chat for the online meeting in response to determining that the user is screen sharing on the device while accessing the link.

Some implementations relate to a device. The device includes a processor; memory in electronic communication with the processor; and instructions stored in the memory, the instructions executable by the processor to: receive, from a browser extension on a browser, a link of a webpage accessed via the browser by a user during an online meeting; determine that the user is screen sharing on a device while accessing the link; and send the link to a meeting chat for the online meeting in response to determining that the user is screen sharing on the device while accessing the link.

Some implementations relate to a method. The method includes receiving, at a meeting chat during an online meeting, a uniform resource locator (URL) of a webpage accessed via a browser by a user screen sharing during the online meeting. The method includes using assistive tools to access the webpage via the URL.

Some implementations relate to a device. The device includes a processor; memory in electronic communication with the processor; and instructions stored in the memory, the instructions executable by the processor to: receive, at a meeting chat during an online meeting, a uniform resource locator (URL) of a webpage accessed via a browser by a user screen sharing during the online meeting; and use assistive tools to access the webpage via the URL.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for online meetings in accordance with implementations of the present disclosure.

FIG. 2 illustrates an example graphical user interface of an online meeting invitation with an icon for sharing links during the online meeting in accordance with implementations of the present disclosure.

FIG. 3 illustrates an example graphical user interface of an online meeting with an icon for sharing links during the online meeting in accordance with implementations of the present disclosure.

FIG. 4 illustrates an example method for detecting links presented by a user during screen sharing in an online meeting and providing the links to a meeting chat for the online meeting in accordance with implementations of the present disclosure.

FIG. 5 illustrates an example method for accessing links from a meeting chat for an online meeting in accordance with implementations of the present disclosure.

FIG. 6 illustrates components that may be included within a computer system.

### DETAILED DESCRIPTION

This disclosure generally relates to online meetings. Online meetings are a vital part for both working and non-working organizations. Users at remote locations communicate to one another in a collaborative environment using online meeting applications. The online meeting applications allow users to share their screen during online meetings, which may have distinct contents, such as, audio, video, and/or images. The shared screen may contain links associated with important context for the online meetings. The shared content may also have website links or web pages. The website links may be helpful for the meeting attendees, and they often may need to view or click on the website links during the live meeting. One issue with online meetings is that the links need to be typed in the meeting chat and/or a messaging box associated with the online meeting for the audience to access.

Another issue with online meetings is that screen readers are unable to interact with screen sharing sessions during online meetings. If the presenter puts the links shared during the screen sharing session in the meeting chat, meeting attendees with special needs, such as, individuals with no or low vision, or individuals that require translation of the shared content, can use assistive tools (e.g., the screen readers or translations) to understand the content of the links shared during the screen sharing session. It is quite tedious for the presenter to share the links in a meeting chat and/or messaging box while presenting during the online meeting.

The methods and systems of the present disclosure automatically detects the links presented by the users during a screen sharing session and provides the links in the meeting chat in near real time. The methods and systems of the present disclosure make online meetings more inclusive for audiences. The methods and systems automatically detect the links presented by the users through screen sharing during the online meeting and posts the links in the meeting chat in near real time, creating a more inclusive meeting for all attendees of the meetings. The list of links provided in the meeting chat also makes the online meeting more inclusive for attendees who missed the online meeting and creates a useful context for everyone to refer to for the online meeting.

The methods and systems of the present disclosure use one component to detect the links shared by the presenter as the presenter is screen sharing during the online meeting. One example of the component to detect the links shared by the presenter is a browser extension. As such, the browser extensions automatically identifies the links shared by a presenter during an online meeting as the presenter is screen sharing. In some implementations, the first component runs on the presenter's device. For example, the browser extension runs on the presenter's device. In some implementations, the first component runs on all devices attending the online meeting (e.g., the meeting attendees' devices).

The methods and systems of the present disclosure use a second component to post the detected links in the meeting chat. In some implementations, the second component is hosted as a service as a chat bot service. In some implementations, the meeting application implements both components (e.g., the browser extension and the chat bot service) and identifies the links in the browser shared by the presenter during a screen sharing session using an application programming interface (API) and provides the links to the chat session using a meeting application messaging service.

One example use case of the methods and systems is an icon is included in the online meeting invitations that a meeting organizer selects to share the links during a presentation mode or screen sharing mode of the online meeting to a meeting chat associated with the online meeting. For example, the links are uniform resource locators (URLs) of webpages shared during the online meeting. As such, the URLs shared during screen sharing of the online meeting are automatically detected and added to the meeting chat for the online meeting. By selecting the icon to share the links in the meeting chat as part of the online meeting invitation, the online meeting becomes inclusive allowing all meeting attendees access to the links and access to the content from the links. In addition, the chat history stores the links shared during the online meeting so that meeting attendees may view the links days after the online meeting.

One technical advantage of the methods and systems of the present disclosure is creating a more inclusive online meeting for all meeting attendees, including the meeting attendees with special needs, such as, a meeting attendee with no or low vision, or meeting attendees that require translation of the shared content. The meeting attendee may open the posted links and read the information from the links using assistive tools, such as, a screen reader or a translator. The list of links provided in the meeting chat also makes it more inclusive for meeting attendees who missed the online meeting and creates a useful context for the meeting attendees to refer to for the online meeting.

As such, the methods and systems of the present disclosure identifies the links shared during a screen sharing session of an online meeting and directly puts the links into a chat session for the online meeting.

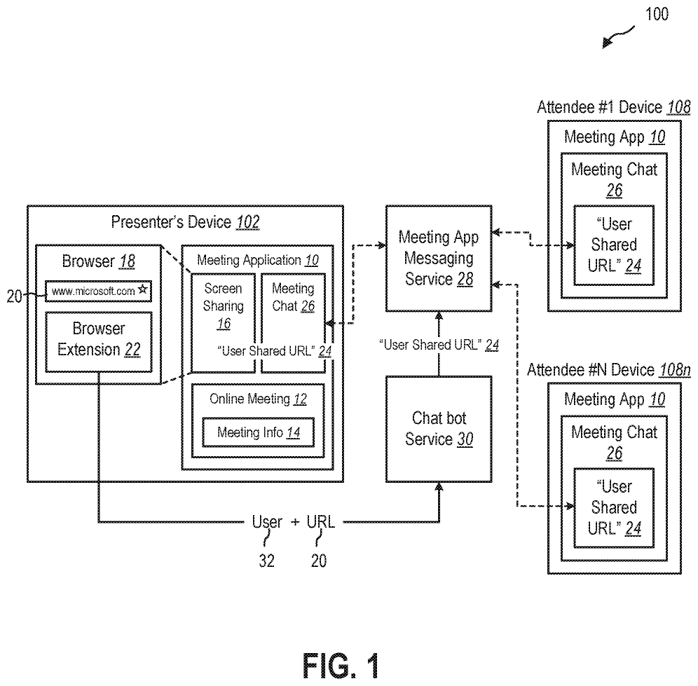

Referring now to FIG. 1, illustrated is an example environment 100 for online meetings 12 using a meeting application 10. The online meeting 12 is a meeting conducted over the Internet between users. Example users of the meeting application 10 include meeting attendees (e.g., an organizer of the online meeting 12 and individuals invited to participate in the online meeting 12). The online meeting 12 allows users to share their screen, which may have distinct contents, such as, text, audio, video, and/or images, during the online meeting 12. The shared content may also have website links (e.g., the URLs 20) or web pages. The website links may be helpful for the meeting attendees, and the meeting attendees often may need to view or click on the website links (e.g., the URLs 20) during the online meeting 12. The shared content is presented on displays of the presenter's device 102 (e.g., the meeting attendee screen sharing 16) and the displays of the meeting attendees' devices 108 so all the meeting attendees of the online meeting 12 may view the shared content at the same time.

In some implementations, the meeting application 10 is an application on the devices of the meeting attendees (e.g., the presenter's device 102 and/or the attendee's device 108). In some implementations, the meeting application 10 is on a server (e.g., a cloud server) remote from the devices of the meeting attendees (e.g., the presenter's device 102 and/or the attendee's devices 108 (up to 108n, where n is a positive integer) accessed, for example, using a web browser on the devices of the meeting attendees via a network. The network may include one or multiple networks that use one or more communication platforms or technologies for transmitting data. For example, the network may include the Internet or other data link that enables transport of electronic data between respective devices of the environment 100.

The online meeting 12 includes meeting information 14. In some implementations, the meeting information 14 is obtained from a meeting invitation created for the online meeting 12. For example, the meeting information 14 indicates the meeting attendees (e.g., the meeting organizer and the individuals invited to participate in the online meeting 12). Another example of the meeting information 14 includes a time and day for the online meeting 12. Another example of the meeting information 14 includes information indicating that sharing links in the meeting chat 26 is enabled during the online meeting 12.

In some implementations, the meeting information 14 is obtained during the online meeting 12. For example, the meeting information 14 includes sharing content is enabled during the online meeting 12. Another example of the meeting information 14 includes sharing links is enabled during a presenting mode (e.g., a screen sharing 16 session during the online meeting 12). Another example of the meeting information 14 is a user identification 32 of the meeting attendee (e.g., a presenter) that is screen sharing 16 during the online meeting 12. Another example of the meeting information 14 is a meeting chat 26 associated with the online meeting 12. As such, a variety of meeting information 14 is obtained by the meeting application 10 for the online meeting 12 before the online meeting 12 starts and/or during the online meeting 12.

The online meeting attendee's devices (e.g., the presenter device 102 and the attendee's devices 108 up to 108 n) may include one or more browsers 18 that allow the online meeting attendees to interact with information on the World Wide Web. When a meeting attendee requests a webpage (e.g., by performing a search using the browser 18 or entering in a uniform resource locator (URL) 20 of a webpage using the browser 18), the browser 18 retrieves the content of the webpage from a webserver and displays the webpage on a display of the online meeting attendee's device (e.g., the presenter's device 102 and/or the attendee's device 108). The browser 18 may be a browser application on an attendee's device 102 (e.g., the presenter's device 102 and/or the attendee's device 108). Examples of browsers 18 include, but are not limited to, EDGE™ and INTERNET EXPLORER™.

If the meeting information 14 indicates that sharing links is enabled during the online meeting 12, a browser extension 22 is enabled on the browsers 18 of the meeting attendee's devices (e.g., the presenter's device 102 and the attendee's devices 108). The browser extension 22 is a software module that runs within the browser and adds or customizes functionality of the browser 18. The browser extension 22 detects events on the browser 18. Example events includes opening a new window in the browser, opening a new tab in the browser, and/or accessing a new webpage in the browser (e.g., by performing a search using the browser 18 or entering in a uniform resource locator (URL) of a webpage using the browser 18). The browser extension 22 identifies the URL(s) 20 of the webpage(s) accessed during the events. In some implementations, the browser extension 22 applies one or more filters to the identified URLs (20) of the webpages to remove restricted URLs (20), offensive content, advertisements, and/or any intermediate webpages.

In some implementations, the meeting attendees enable the browser extension 22. For example, the meeting attendees select an icon on the browser 18 to enable the browser extension 22 prior to the online meeting 12 starting or during the online meeting 12. In some implementations, the browser extension 22 is automatically enabled on the browser 18 in response to the meeting organizer enabling sharing links in the meeting invitation. In some implementations, the browser extension 22 is automatically enabled on the browser 18 in response to a meeting attendee (e.g., a presenter with a screen sharing 16 session) enabling sharing links during the online meeting 12.

The browser extension 22 sends the identified URLs 20 to a chat bot service 30 associated with the online meeting 12. In addition, the browser extension 22 sends a user identification (ID) 32 of the meeting attendee accessing the identified URL 20. In some implementations, the chat bot service 30 is added to the online meeting 12 by a meeting attendee prior to the online meeting 12 starting or during the online meeting 12. In some implementations, the chat bot service 30 is automatically added to the online meeting 12 by the meeting application 10 in response to enabling sharing links for the online meeting 12 (e.g., enabling an icon in the meeting invitation for sharing links or enabling an icon for sharing links during the online meeting). In some implementations, the chat bot service 30 is added to the meeting application 10.

The chat bot service 30 receives a notification with the meeting information 14 for the online meeting. For example, the chat bot service 30 subscribes to the meeting application 10 notifications and receives the notifications from the meeting application 10. The notification includes the list of attendees of the online meeting 12 and whether an attendee is screen sharing 16. The chat bot service 30 receives the URLs 20 accessed by the user and the user ID 32 of the user accessing the URLs 20 from the browser extension 22. The chat bot service 30 uses the meeting information 14 in the notification to determine whether screen sharing 16 is enabled for the online meeting 12. If the chat bot service 30 determines that screen sharing 16 is not enabled during the online meeting 12, the chat bot service 30 ignores, or otherwise discards, the URL 20.

If meeting attendee associated with the user ID 32 accessing the URL 20 is screen sharing 16 (e.g., the meeting attendee selecting an icon during the online meeting 12 for screen sharing 16), the chat bot service 30 determines that screen sharing 16 is enabled. In some implementations, the meeting attendee that is screen sharing 16 is identified as a presenter and the device of the meeting attendee that is screen sharing 16 is identified as a presenter's device 102. The chat bot service 30 automatically sends the URLs 20 accessed by the meeting attendee associated with the user ID 32 that is screen sharing 16 to a meeting application messaging service 104. As such, the chat bot service 30 automatically sends the URLs 20 in response to determining that screen sharing 16 is enabled during the access of the URLs 20. In some implementations, the chat bot service 30 sends the user ID 32 of the presenter that is screen sharing 16 to the meeting application messaging service 104.

The meeting application messaging service 28 sends a message 24 to the meeting chat 26 associated with the online meeting 12 with the URL 20 that is accessed by the presenter during the screen sharing 16 of the online meeting 12. For example, the message 24 identifies the user that shared the URL 20 and the message 24 also provides a link to the URL 20 that can be clicked or otherwise accessed. The meeting chat 26 allows the meeting attendees to send instant messages to one another. In some implementations, the message 24 identifies the presenter. For example, the message 24 indicates that the username of the presenter shared the URL 20 and the message 24 also provides a link to the URL 20 that can be accessed using the meeting chat 26.

In some implementations, the browser extension 22 sends the identified URLs 20 to the meeting application messaging service 28 and the meeting application messaging service 28 receives a notification with the meeting information 14 for the online meeting. The meeting application messaging service 28 uses the meeting information 14 in the notification to determine whether screen sharing 16 is enabled for the online meeting 12. If the meeting application messaging service 28 determines that the screen sharing 16 is enabled, the meeting application messaging service 28 sends a message 24 to the meeting chat 26 associated with the URL 20 that is accessed by the presenter during the screen sharing 16 of the online meeting 12.

The displays of the online meeting attendee's devices 108 provides the screen sharing 16 so that the webpage associated with the URL 20 is presented and the URLs 20 of webpage presented in the screen sharing 16 is also provided in the meeting chat 26. In some implementations, the meeting chat 26 with the URLs 20 is presented adjacent to the screen sharing 16. As such, each of the meeting attendees may access the URLs 20 in the meeting chat 26 at the same time the screen sharing 16 is occurring.

By automatically providing the URLs 20 accessed during screen sharing 16 of the online meeting 12, the online meeting 12 is an inclusive meeting for all meeting attendees, including meeting attendees with special needs. For example, a meeting attendee with no or low vision may use a screen reader on the meeting attendee's device to access the URL 20 in the meeting chat 26 to aid the meeting attendee in understanding the content shared during the screen sharing 16 of the online meeting 12. The screen reader provides the meeting attendee with the content of the webpage accessed by the presenter during the screen sharing 16 and the meeting attendee can understand the content shared during the online meeting 12.

Another example includes a meeting attendee that requires translation of the shared content during the online meeting 12 (e.g., a meeting attendee that uses a different language than the presenter). The meeting attendee may use a translation service on the meeting attendee's device to access the URL 20 in the meeting chat 26 so that the translation service provides the meeting attendee with translated content of the webpage into a language that the meeting attendee understands, allowing the meeting attendee to understand the content shared during the online meeting 12.

By automatically posting the URLs 20 to the meeting chat 26, the online meeting 12 is more inclusive for the meeting attendees who missed the online meeting 12. The meeting attendees who missed the online meeting 12 may refer to the URLs 20 after the online meeting finishes. Automatically posting the URLs 20 to the meeting chat 26 also creates a useful context for all meeting attendees to refer to for the online meeting.

In some implementations, one or more computing devices are used to perform the processing of environment 100. The one or more computing devices may include, but are not limited to, server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the meeting application 10, the browser 18, the meeting application messaging service 28, and/or the chat bot service 30 are implemented wholly on the same computing device. Another example includes one or more subcomponents of the meeting application 10, the meeting application messaging service 28, and/or the chat bot service 30 implemented across multiple computing devices. Moreover, in some implementations, the meeting application 10, the browser 18, the meeting application messaging service 28, and/or the chat bot service 30 are implemented or processed on different server devices of the same or different cloud computing networks. Moreover, in some implementations, the features and functionalities are implemented or processed on different server devices of the same or different cloud computing networks.

As such, the environment 100 automatically detects the URLs 20 presented by the meeting attendees during screen sharing 16 of the online meeting 12 and provides the URLs 20 the meeting chat 26 in near real time, creating a more inclusive online meeting 12 for all meeting attendees. By automatically detecting the URLs 20 of the webpages accessed during screen sharing 16 of the online meetings 12 and sharing the URLs 20 the meeting chat 26, the online meetings 12 meeting continues without interruptions requesting that the URLs 20 get added to the meeting chat 26. The meeting attendees may use assistive tools to follow the information in the webpages as the presenter shares the webpages during the screen sharing 16 by receiving the messages 24 in the meeting chat 26 as the new links arrive in the meeting chat 26 and access the links using the assistive tools to open the webpages and understand the content of the webpages.

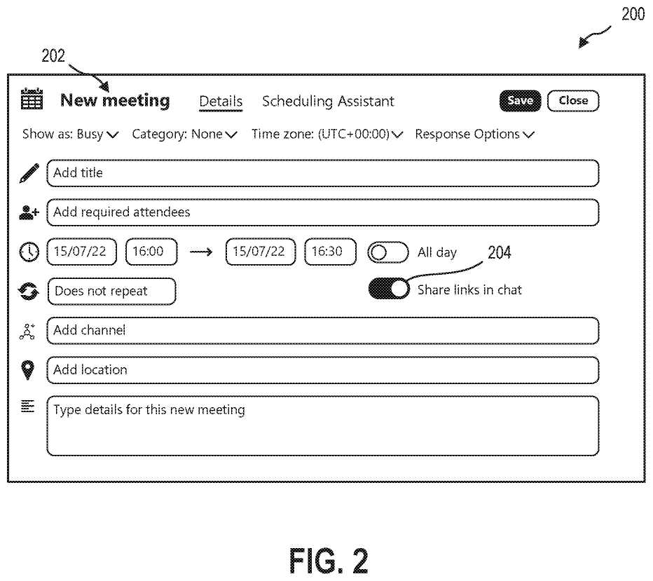

Referring now to FIG. 2, illustrated is an example user interface 200 of a new meeting invitation 202 for an online meeting 12 (FIG. 1). The meeting invitation 202 includes an icon 204 that enables sharing links in the meeting chat 26 (FIG. 1) during the online meeting 12. By enabling sharing links during the online meeting 12, the browser extension 22 (FIG. 1) and the chat bot service 30 (FIG. 1) are enabled for the online meeting 12. Moreover, by enabling sharing links during the online meeting 12, the links of the webpages (e.g., the URLs 20 (FIG. 1) of the webpages) accessed during a screen sharing 16 session of the online meeting 12 are automatically detected by the browser extension 22 and sent to the chat bot service 30 (FIG. 1). The chat bot service 30 automatically sends the URLs 20 detected during a screen sharing 16 session of the online meeting 12 to the meeting chat 26 for the online meeting 12. As such, the icon 204 allows the meeting organizer to make the online meeting 12 more inclusive by enabling sharing links prior to the start of the online meeting 12.

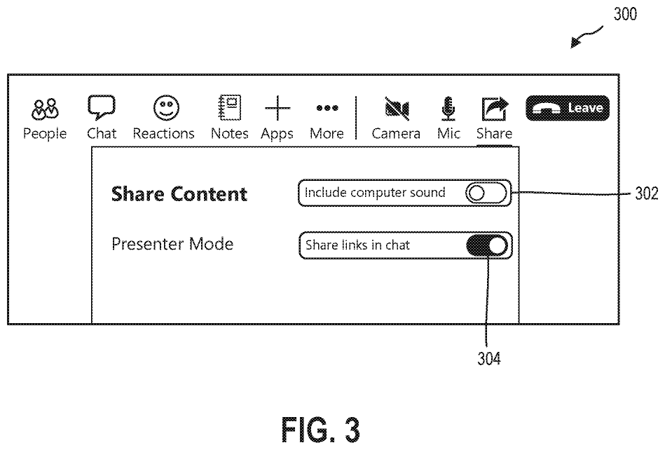

Referring now to FIG. 3, illustrated is an example user interface 300 of an online meeting 12 (FIG. 1). The user interface 300 is displayed during an online meeting 12. The user interface 300 includes an icon 302 that enables screen sharing 16. If a meeting attendee selects the icon 302, the meeting attendee is designated as a presenter and the content on the display of the presenter's device 102 (FIG. 1) is shared with the other meeting attendees of the online meeting 12.

The user interface 300 also includes an icon 304 that enables sharing links in the meeting chat 26 (FIG. 1). By enabling sharing links during the online meeting 12, the browser extension 22 (FIG. 1) and the chat bot service 30 (FIG. 1) are enabled for the online meeting 12. In addition, by enabling sharing links during the online meeting 12, the links (e.g., the URLs 20 (FIG. 1) of the webpages accessed by the presenter during a screen sharing 16 session of the online meeting 12 are automatically detected by the browser extension 22 and provided to the meeting chat 26. If the presenter selects the icon 302 to start screen sharing 16 and the presenter selects the icon 304 to enable sharing links, the URLs 20 of the webpages accessed by the presenter during the screen sharing 16 are automatically detected and shared to the meeting chat 26. By selecting the icon 304 during the online meeting 12, the online meeting 12 is more inclusive by enabling sharing links during the online meeting 12 to the meeting chat 26. In some implementations, the icon 304 is automatically selected if the meeting organizer selected the icon 204 (FIG. 2) in the meeting invitation 202.

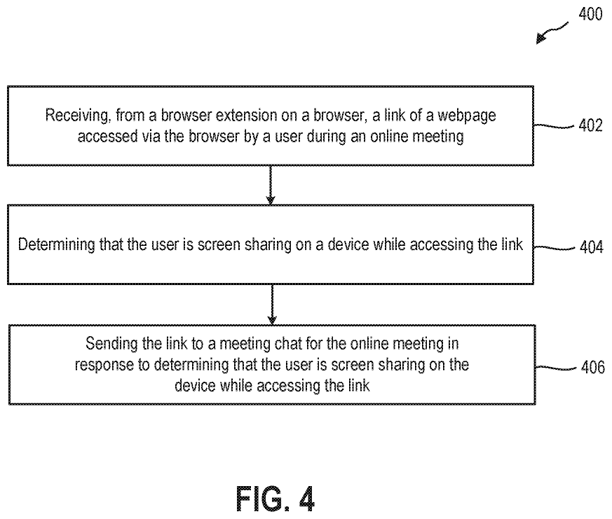

Referring now to FIG. 4, illustrated is an example method 400 for detecting links presented by a user during screen sharing in an online meeting and providing the links to a meeting chat for the online meeting. The actions of the method 400 are discussed below with reference to the architecture of FIGS. 1-3.

At 402, the method 400 includes receiving from a browser extension on a browser a link of a webpage accessed via the browser by a user during an online meeting. The chat bot service 30 receives from the browser extension 22 a link of a webpage accessed via the browser 18 by a user (e.g., a meeting attendee) during an online meeting 12. In some implementations, the link is a uniform resource locator (URL) 20 of the webpage.

The browser extension 22 automatically detects the link (e.g., the URL 20) of a webpage accessed via the browser 18 by the user (e.g., a meeting attendee) during the online meeting 12. In some implementations, the browser extension 22 detects the link (e.g., the URL 20) during an event on the browser 18. For example, the event is one or more of opening a new window in the browser 18, opening a new tab in the browser 18, or accessing the webpage in the browser 18 (e.g., by performing a search using the browser 18 or entering in a uniform resource locator (URL) 20 of a webpage using the browser 18). In some implementations, the browser extension 22 is enabled prior to a start of the online meeting 12. For example, a meeting attendee selects an icon in the browser 18, enabling the browser extension 22. In some implementations, the browser extension 22 is enabled during an online meeting 12. For example, a meeting attendee selects an icon in the browser 18, enabling the browser extension 22 during the online meeting 12.

In some implementations, the browser extension 22 and the chat bot service 30 are automatically enabled prior to the start of the online meeting 12 by the meeting application 10. For example, an icon (e.g., the icon 204) in a meeting invitation (e.g., the meeting invitation 202) for the online meeting 12 is selected to share links. The browser extension 22 is automatically enabled on the browser 18 by the meeting application 10 and the chat bot service 30 is automatically enabled by the meeting application 10 prior to a start of the online meeting 12 in response to a selection of the icon (e.g., the icon 204) in the meeting invitation (e.g., the meeting invitation 202). In some implementations, an icon (e.g., the icon 304) to share links is selected during the online meeting 12. The browser extension 22 is automatically enabled on the browser 18 by the meeting application 10 and the chat bot service 30 is automatically enabled during the online meeting 12 by the meeting application 10 in response to a selection of the icon (e.g., the icon 304) during the online meeting 12.

At 404, the method 400 includes determining that the user is screen sharing on a device while accessing the link. The chat bot service 30 determines that the user is screen sharing 16 (e.g., the meeting attendee that is presenting associated with the user ID 32) on a device (e.g., the presenter device 102) while accessing the link (e.g., the URL 20). In some implementations, the chat bot service 30 receives a notification from the meeting application 10 with the meeting information 14 for the online meeting 12 and the chat bot service 30 uses the meeting information 14 to determine that screen sharing 16 is enabled during the online meeting 12. For example, the meeting information 14 includes information indicating that an icon (e.g., the icon 302) is selected during the online meeting 12 to enable screen sharing 16. As such, the chat bot service 30 uses the meeting information 14 indicating that the icon 302 is selected to determine that screen sharing 16 is enabled during the online meeting 12.

At 406, the method 400 includes sending the link to a meeting chat for the online meeting in response to determining that the user is screen sharing on the device while accessing the link. The chat bot service 30 sends the link (e.g., the URL 20) in near real time during the online meeting 12 to the meeting chat 26 in response to determining that the user is screen sharing 16 on the device (e.g., the presenter device 102) while accessing the link (e.g., the URL 20). In some implementations, the chat bot service 30 sends the link (e.g., the URL 20) to a meeting application messaging service 28 and the meeting application messaging service 28 sends the link (e.g., the URL 20) in near real time to the meeting chat 26.

In some implementations, a message is provided in the meeting chat 26. The message identifies the user (e.g., the user ID 32, the username, or other identification of the user) screen sharing 16 and the link (e.g., the URL 20) accessed by the user. The meeting chat 26 stores the links (e.g., the URLs 20), allowing access to the links (e.g., the URLs 20) after a conclusion of the online meeting 12. As such, any meeting attendees may access the URLs 20 using the meeting chat 26 after the conclusion of the online meeting 12. In some implementations, the meeting chat 26 provides a summary of all the URLs 20 shared at the end of the online meeting 12 using the URLs 20 stored in the meeting chat 26. For example, all the URLs 20 are included in a single message 24 in the meeting chat 26.

The method 400 creates a more inclusive online meeting 12 for all meeting attendees by automatically detecting the URLs 20 of the webpages accessed during screen sharing 16 of the online meeting 12 and sharing the URLs 20 in the meeting chat 26 in near real time during the screen sharing 16 of the online meeting 12.

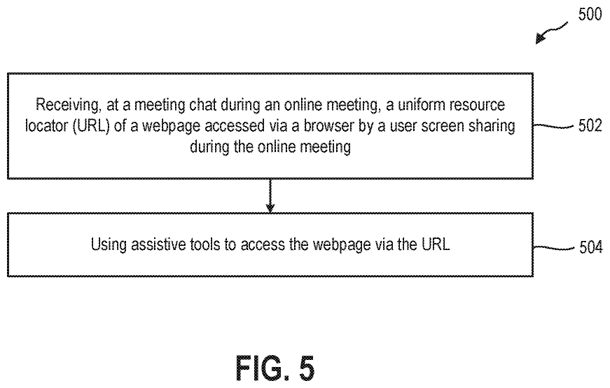

Referring now to FIG. 5, illustrated is a method 500 for accessing links from a meeting chat associated with an online meeting. The actions of the method 500 are discussed below with reference to the architecture of FIGS. 1-3.

At 502, the method 500 includes receiving, at a meeting chat during an online meeting, a URL of a webpage accessed via a browser by a user screen sharing during the online meeting. The meeting chat 26 for the online meeting 12 receives in near real time a URL 20 of a webpage accessed via a browser 18 by a user that is screen sharing 16 (e.g., a meeting attendee presenting) during the online meeting 12. The URL 20 is automatically detected during screen sharing 16 of the online meeting 12 by a browser extension 22 and the URL 20 is sent to the meeting chat 26 in near real time by a meeting application messaging service 28.

At 504, the method 500 includes using assistive tools to access the webpage via the URL. A meeting attendee with special needs (e.g., low vision or no vision or uses a different language than the language used during the online meeting 12) may have assistive tools on the meeting attendee device (e.g., the meeting attendee device 108) to aid the meeting attendee during the online meeting 12 in understanding the online meeting 12 or the content shared during the online meeting 12. In some implementations, the assistive tools is a screen reader. In some implementations, the assistive tools is a translation service. The meeting attendee opens the posted URLs 20 in the meeting chat 26 using the assistive tools and uses the assistive tools to understand the information from the webpage.

The assistive tools access the webpage via the URL 20 from the meeting chat 26 and performs processing on the webpage to aid the meeting attendee in understanding the content of the webpage shared during the online meeting 12. In some implementations, the URL 20 is accessed from the meeting chat 26 after completion of the online meeting 12. In some implementations, the meeting chat 26 provides a summary of all the URLs 20 shared at the end of the online meeting 12 using the URLs 20 stored in the meeting chat 26. For example, the meeting application messaging service 28 provides an aggregation of all the URLs 20 stored in the meeting chat 26 in a single message 24 in the meeting chat 26.

As such, the method 500 is makes it easier for all meeting attendees (including the meeting attendees with special needs, such as, a meeting attendee with no or low vision, or meeting attendees that require translation of the shared content) to understand or hear what is being shown by the presenter during screen sharing of an online meeting.

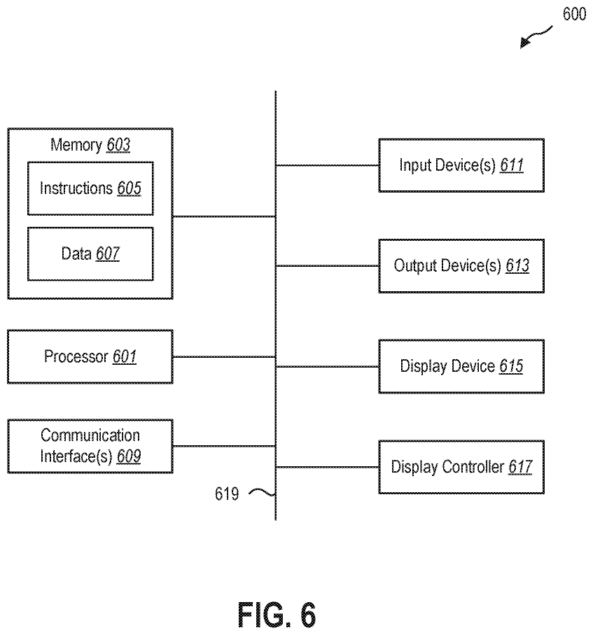

FIG. 6 illustrates components that may be included within a computer system 600. One or more computer systems 600 may be used to implement the various methods, devices, components, and/or systems described herein.

The computer system 600 includes a processor 601. The processor 601 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used.

The computer system 600 also includes memory 603 in electronic communication with the processor 601. The memory 603 may be any electronic component capable of storing electronic information. For example, the memory 603 may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
receiving, from a browser extension on a browser, a link of a webpage accessed via the browser by a user during an online meeting;
determining that the user is screen sharing on a device while accessing the link; and
sending the link to a meeting chat for the online meeting in response to determining that the user is screen sharing on the device while accessing the link.

2. The method of claim 1, wherein the link is a uniform resource locator (URL) of the webpage.

3. The method of claim 1, further comprising:
providing a message in the meeting chat, wherein the message identifies the user that is screen sharing and the link accessed by the user.

4. The method of claim 1, wherein determining that the user is screen sharing on the device further includes:
receiving a notification with meeting information for the online meeting; and
using the meeting information to determine that screen sharing is enabled during the online meeting.

5. The method of claim 1, wherein the browser extension detects the link during an event on the browser.

6. The method of claim 5, wherein the event is one or more of opening a new window in the browser, opening a new tab in the browser, or accessing the webpage in the browser.

7. The method of claim 1, wherein a chat bot service receives, from the browser extension on the browser, the link of the webpage accessed.

8. The method of claim 7, wherein the chat bot service determines that the user is screen sharing on the device while accessing the link.

9. The method of claim 8, further comprising:
selecting an icon in a meeting invitation for the online meeting to share links; and
enabling the browser extension on the browser for sharing uniform resource locator (URL)s of webpages and the chat bot service prior to a start of the online meeting in response to selecting the icon.

10. The method of claim 8, further comprising:
selecting an icon to share links during the online meeting; and
enabling the browser extension on the browser sharing uniform resource locator (URL)s of webpages and the chat bot service during the online meeting in response to selecting the icon.

11. The method of claim 1, further comprising:
enabling the browser extension sharing uniform resource locator (URL)s of webpages prior to a start of the online meeting.

12. The method of claim 1, further comprising:
enabling the browser extension sharing uniform resource locator (URL)s of webpages during the online meeting.

13. The method of claim 1, further comprising:
providing a summary of all links shared at an end of the meeting using the links stored in the meeting chat.

14. The method of claim 1, wherein the browser extension automatically detects the link of a webpage accessed via the browser by the user during the online meeting.

15. A device, comprising:
a processor;
memory in electronic communication with the processor; and
instructions stored in the memory, the instructions being executable by the processor to:
receive, at a meeting chat during an online meeting, a uniform resource locator (URL) of a webpage accessed via a browser by a user screen sharing during the online meeting; and
use assistive tools to access the webpage via the URL.

16. The device of claim 15, wherein the assistive tools is a screen reader.

17. The device of claim 15, wherein the assistive tools is a translation service.

18. The device of claim 15, wherein the instructions are further executable by the processor to:
receive, at the meeting chat, in near real time the URL of the webpage accessed via the browser by the user during screen sharing of the online meeting.

19. The device of claim 15, wherein the URL is automatically detected during the screen sharing of the online meeting and the URL is sent to the meeting chat in near real time.

20. The device of claim 15, wherein the URL is accessed from the meeting chat after completion of the online meeting.
